(19) United States
(12) Patent Application Publication
(10) Pub. No.: US 2025/0295967 A1
(43) Pub. Date: Sep. 25, 2025

(54) INTEGRATED STRUCTURE PICKLEBALL PADDLE AND PREPARATION PROCESS THEREOF

(71) Applicant: Dongguan Xinshuo Composite Material Technology Co., Ltd., Dongguan (CN)

(72) Inventor: Tongliang ZHENG, Dongguan (CN)

(73) Assignee: Dongguan Xinshuo Composite Material Technology Co., Ltd., Dongguan (CN)

(21) Appl. No.: 19/082,254

(22) Filed: Mar. 18, 2025

(30) Foreign Application Priority Data
Mar. 22, 2024 (CN) 202410334307.9

(51) Int. Cl. A63B 60/54; A63B 59/42; A63B 102/08; B32B 3/12; B32B 27/12; B32B 27/32; C08G 71/04

(52) U.S. Cl. CPC A63B 60/54; A63B 59/42; B32B 3/12; B32B 27/12; B32B 27/32; C08G 71/04; A63B 2102/08; A63B 2209/02; B32B 2250/03; B32B 2262/101; B32B 2262/106

(57) ABSTRACT

An integrated structure pickleball paddle and a preparation process thereof are provided, where the pickleball paddle includes a paddle body, an edge banding, and a handle, where the edge banding and the paddle body are fused into an integrated structure by hot pressing, where the material of the edge banding is a modified TPU composite material, where the modified TPU composite material includes the following raw materials in parts by mass: 90-100 parts of modified TPU, 9-14 parts of polyvinyl fluoride, 20-30 parts of epoxy resin, 10-20 parts of ABS resin, 5-10 parts of modified nano-silicon dioxide, 0.3-0.6 parts of antioxidant, 0.2-0.5 parts of fluidity aid, 4-9 parts of 4,4′-methylene-bis(2-chloroaniline), and 3-7 parts of silicone oil. The edge banding and the paddle body are hot pressed and fused into an integrated structure, the edge banding will not fall off, and the comprehensive performance of the edge banding is better.

### CROSS REFERENCE TO THE RELATED APPLICATIONS

This application is based upon and claims priority to Chinese Patent Application No. 202410334307.9, filed on Mar. 22, 2024, the entire contents of which are incorporated herein by reference.

### TECHNICAL FIELD

This invention belongs to the field of paddle technology, specifically involving an integrated structure pickleball paddle and a preparation process thereof.

### BACKGROUND

Pickleball is a sport that originated from Benbridge Island in Seattle, USA. It is a new sport formed by the combination of tennis, badminton, and table tennis. In the United States, about 2.5 million people are engaged in this sport all year round, and it has become a sports item in middle school physical education classes. The basic structure of a pickleball paddle is shown in FIG. 1, and the production process is shown in FIG. 2. The paddle usually includes a paddle body, an edge banding, and a handle. The edge banding is bonded to the periphery of the paddle body by an adhesive, such as epoxy resin, to achieve the function of protecting the paddle body, as shown in FIG. 3. The paddle body of a pickleball paddle has the following structure as shown in FIG. 4. The paddle core usually includes a honeycomb made of polypropylene (PP), aramid, aluminum, etc., and the paddle surface includes carbon fiber or glass fiber, and the surface material is pressed on the surface of the paddle core. In the prior art, the paddle core, surface, and foam strip are assembled into a preliminary blank, the cut surface is placed on the paddle core, and the silencing strip is wrapped around the paddle core to form a blank. The blank in this process is not integrated, that is, the paddle core, surface, and silencing strip are not fused into one piece. Then the blank is put into the mold for hot pressing to form the paddle body. The blank made in the previous step is put into the mold for high-temperature hot pressing. After hot pressing, the paddle core, surface, and silencing strip are fused together to form the paddle body. In this process, the mold and the blank fit perfectly, that is, there is no gap between the blank and the mold, as shown in FIG. 5. Then the edge banding is prepared in advance, and only need to be installed on the paddle through adhesive. The edge banding installed by this method will affect the appearance and performance of the paddle. The edge banding installed by this method is not strong enough, has immeasurable gaps, and is prone to falling off, as shown in FIG. 6.

From the above introduction, it can be seen that the current method of making and installing the edge banding of a pickleball paddle is as follows:
1) customize the finished edge banding of the corresponding width in advance;
2) use adhesive to glue the edge banding to the paddle.

The paddle, of which the edge banding is made and installed by this method, has the following obvious disadvantages:
1) the edge banding and the paddle are not integrated. They are only glued by adhesive. The edge banding cannot be integrated with the paddle face, resulting in unequal gaps and likelihood of the edge banding falling off.

2) the edge banding installed by this method has a convex part compared to the paddle body, which affects the appearance.

3) the edge banding and the paddle are not integrated. When swinging the paddle, the paddle is prone to vibration, affecting the effect of the paddle.

### SUMMARY

The purpose of the present invention is to provide an integrated structure pickleball paddle and preparation process thereof.

In order to achieve the above purpose, the present invention provides the following technical solutions:
An integrated structure pickleball paddle, the pickleball paddle includes a paddle body, an edge banding, and a handle, the edge banding and the paddle body are fused into an integrated structure by hot pressing, the material of the edge banding is a modified thermoplastic polyurethane (TPU) composite material, and the modified TPU composite material includes the following raw materials in parts by mass: 90-100 parts of modified TPU, 9-14 parts of polyvinyl fluoride, 20-30 parts of epoxy resin, 10-20 parts of acrylonitrile-butadiene-styrene (ABS) resin, 5-10 parts of modified nano-silicon dioxide, 0.3-0.6 parts of antioxidant, 0.2-0.5 parts of fluidity aid, 4-9 parts of 4,4′-methylene-bis(2-chloroaniline), and 3-7 parts of silicone oil.
Polyvinyl fluoride, purchased from DuPont, ETFE 230. Epoxy resin, purchased from Merck, 31185. ABS resin was purchased from Lotte Chemical ABS resin, SD-0150/BK.

Further, the preparation method of the modified TPU is as follows:
(1) mixing polyether diol, silicone prepolymer, diphenylmethane diisocyanate, and organic bismuth catalyst in a mass ratio of (25-30):(25-30):(18-22):(0.03-0.05), heating to 80-90° C., and maintaining the temperature and reacting for 4-5 h to obtain polyurethane prepolymer; and
(2) mixing propylene glycol, trimethylolpropane, and polyurethane prepolymer in a mass ratio of 1:(0.4-0.7):(90-100), continuing to react at 80-90° C. for 3-4 h, capping and cooling to obtain modified TPU.

Further, the weight average molecular weight of the polyether diol is 1000-3000.

Furthermore, the silicone prepolymer is a compound of model Silok®8832F4 silicone prepolymer (Guangzhou Silok), model ChangFu® SP-DN46 silicone prepolymer (Hubei Changfu Chemical Co., Ltd.), and model Silmer NH Di-50 silicone prepolymer (Stai Chemical) with a mass ratio of 1:(0.2-0.4):(0.5-0.7).

Further, the fluidity aid is BASF ADP-1200.

Further, the antioxidant is selected from one or more of antioxidant-264, antioxidant-1010, and antioxidant-1076.

Polyurethane is widely used in the preparation of edge bandings of pickleball paddles due to its excellent performance. It was found in customer feedback that the commercially available edge bandings of TPU material have poor low temperature resistance. After long-term low temperature storage or use, the edge bandings will crack, and pickleball is a sport suitable for both indoor and outdoor use, which undoubtedly affects the service life of the pickleball paddle. After the present invention modifies TPU, the low temperature resistance of the edge banding can be improved. It is speculated that the modified TPU can introduce more flexible segments into the polyurethane molecules, and these flexible segments can better maintain activity at low temperatures, reducing the brittle tendency of polyurethane at low temperatures. At the same time, the glass transition temperature of TPU at low temperatures has been improved after molecular structure adjustment, so that polyurethane maintains good elasticity and toughness at low temperatures; at the same time, it has better compatibility with the other components in the system, thereby improving low temperature resistance. The inventor unexpectedly found that the 5% thermogravimetric temperature ° C. of the edge banding was increased at the same time. It is speculated that the modification makes the molecular structure more stable, which can reduce the decomposition rate of the material at high temperature, thereby increasing the thermogravimetric temperature.

Further, the preparation method of the modified nano-silicon dioxide is: mixing nano-silicon dioxide, solvent, and silicone resin in a mass ratio of 1:(10-12):(0.04-0.08), stirring at 30-45° C. for 3-6 h, and removing the solvent and drying to obtain modified nano-silicon dioxide.

Further, the solvent is a compound of acetone and ethanol with a mass ratio of 1:1.

Further, the model of the silicone resin is Merck, SYLGARD® 184.

The average particle size of nano-silicon dioxide is 10 nm and the specific surface area is 380 m²/g. Purchased from Ningbo Jinlei Nanomaterial Technology, model JL-Si02-N10.

Existing pickleball paddles often have their service life affected by the wear of the edge bandings. The present invention attempts to add silicon dioxide to improve the wear resistance of the edge bandings. However, considering the poor dispersion of nano-silicon dioxide in organic systems, the inventors tried to modify it with a silane coupling agent, but the effect was not very ideal. After a large number of experiments, the present invention modified silicon dioxide to improve the wear resistance of the edge bandings. It is speculated that the modified nano-silicon dioxide has better dispersion in the system and better compatibility with the organic components in the present invention, which will form a certain degree of physical or chemical bonding, thereby improving wear resistance. The inventor unexpectedly found that the tensile strength of the edge bandings was also improved.

Further, the preparation method of the composite material is: mixing modified polyurethane, polyvinyl fluoride, epoxy resin, ABS resin. and 4,4′-methylene-bis(2-chloroaniline) evenly, stirring at a temperature of 220-240° C. for 4-6 h, cooling to 130-140° C., adding the remaining raw materials, and maintaining the temperature and stirring for 3-4 h to obtain a modified TPU composite material.

The present invention also provides a preparation process of the integrated structure pickleball paddle, as shown in FIG. 7, including the following steps:
step 1: cutting the paddle core and paddle surface into the paddle shape.

As shown in FIG. 8, the paddle core material can be polypropylene honeycomb (PP core), aramid honeycomb, aluminum honeycomb, etc. The paddle surface is carbon fiber, glass fiber, etc. To make a paddle, the raw materials need to be cut into a specific paddle shape.
step 2: making a silencing foam strip.

As shown in FIG. 9, use strip-shaped carbon fiber cloth to wrap the foam material to form a silencing strip.
step 3: assembling the paddle core, surface, and foam strips into a paddle body.

As shown in FIG. 10, put the cut surface on the paddle core, and wrap the silencing strip around the paddle core to form a blank, that is, the paddle body. The blank in this process is not integrated, that is, the paddle core, surface, and silencing strip are not fused into one.
step 4: hot pressing.

As shown in FIGS. 11A-11C, the mold used in the production process of the paddle of the present invention is a customized mold. There is a space between the blank and the mold for injecting the raw material of the edge banding. And the mold has an injection port for injecting the raw material of the edge banding. For ordinary molds, the blank and the mold are cut to fit tightly and there is no injection port.

The injection reserved space of the mold can also be controlled according to needs, that is, the thickness of the edge banding can be controlled.

Mold after injection. According to needs, the edge banding can be made flush with the paddle body or slightly cover the paddle surface. The edge banding is flush with the paddle body: the injected raw material and the paddle body are highly consistent, FIGS. 12A-12B. The edge banding slightly covers the paddle surface: the injected raw material covers the edge of the paddle body, FIGS. 13A-13B.

After high-temperature hot pressing, the edge banding and the paddle body are fused together to form a super-integrated paddle.
step 5: printing the pattern on the surface of the paddle body.
step 6: installing the handle.

Compared with the prior art, the advantages and beneficial effects of the present invention are as follows:
1. The present invention provides an integrated structure pickleball paddle and preparation process thereof. When the blank of the present invention is hot-pressed, the raw material of the edge banding is injected into the mold, and the raw material is around the blank. After hot pressing, the edge banding and the paddle body are fused into one to form a super-integrated structure paddle. The mold used in the present invention is a customized mold, that is, there is a certain space between the blank and the mold groove for injecting the raw material of the edge banding. The injection reserved space of the mold of the present invention (the gap between the blank and the mold) can be controlled according to needs, that is, the thickness of the edge banding can be controlled. According to needs, the edge banding and the paddle body can be controlled to be flush, or at the edge of the paddle, the edge banding can cover and wrap 1-5 mm of the paddle face.
2. The paddle of the present invention has the following advantages:
1) The edge banding and the paddle body are hot-pressed and fused into an integrated structure, and the edge banding will not fall off.
2) Whether the edge banding is flush with the paddle face can be controlled according to needs, making the paddle more beautiful.
3) The edge banding and the paddle body are fused into an integrated structure by heat pressing. When the paddle is swung, there will be no paddle vibration, which improves user's experience.

### BRIEF DESCRIPTION OF THE DRAWINGS

FIG. 1 is a schematic diagram of a paddle.

FIG. 2 is a schematic diagram of an edge banding.

FIG. 3 is a perspective view of a paddle body cut.

FIG. 4 is a flowchart of paddle manufacturing in the prior art.

FIG. 5 is a schematic diagram of the blank and the mold in the prior art.

FIG. 6 is a schematic diagram of the installation of the edge banding in the prior art.

FIG. 7 is a flowchart of the manufacturing of the paddle of the present invention.

FIG. 8 is a schematic diagram of the cutting of the paddle core and the paddle of the present invention.

FIG. 9 is a schematic diagram of the manufacturing of the silencing foam strip of the present invention.

FIG. 10 is a schematic diagram of the blank of the present invention.

FIGS. 11A-11C are schematic diagrams of a customized mold.

FIGS. 12A-12B are schematic diagrams of the paddle body flush with the edge banding.

FIGS. 13A-13B are schematic diagrams of the paddle face with a small edge banding covering.

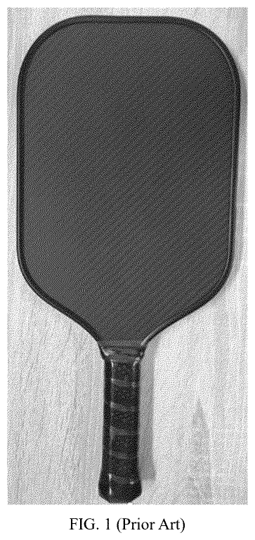

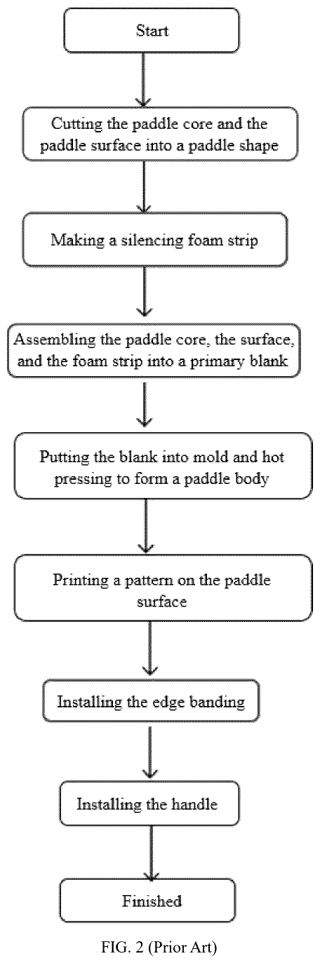

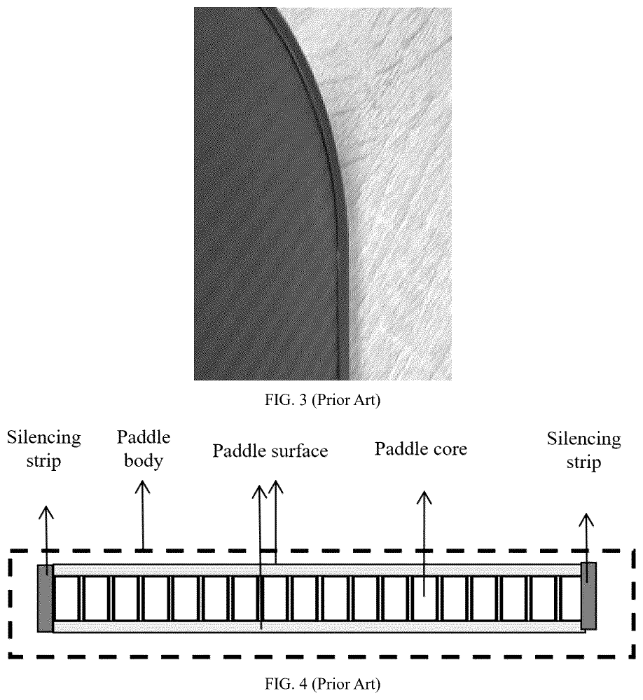

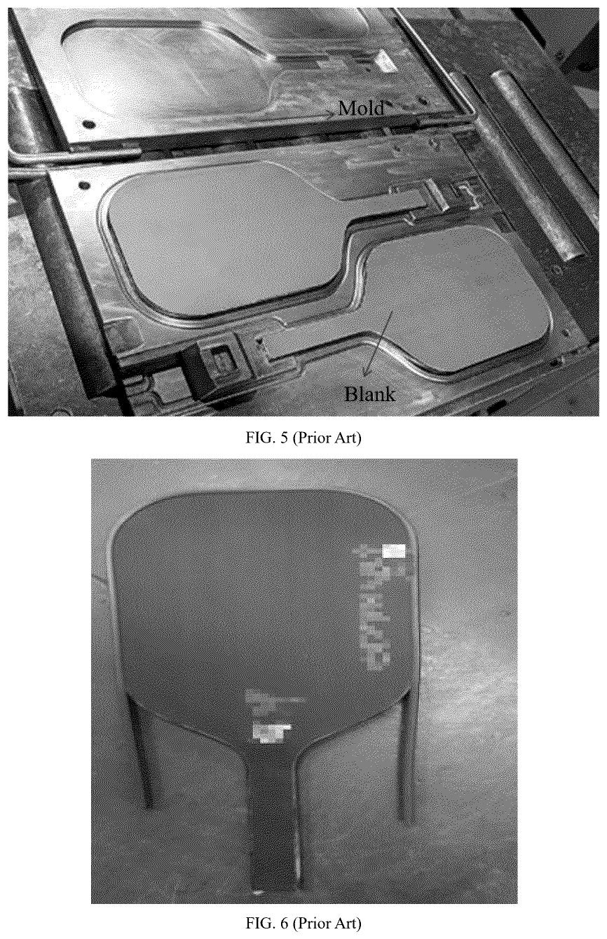

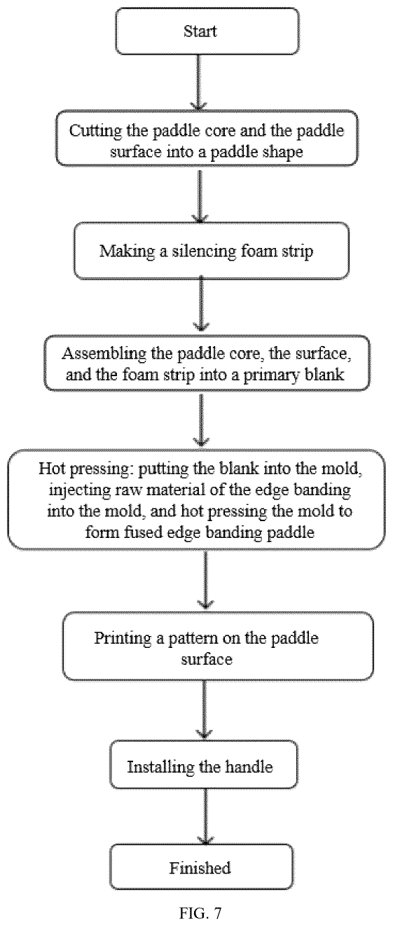

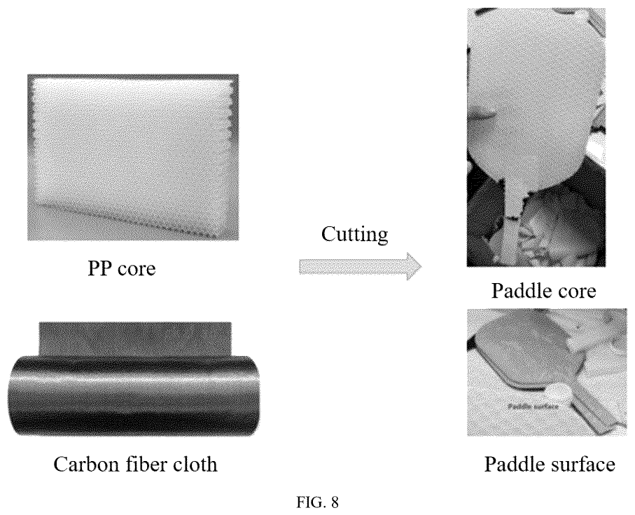

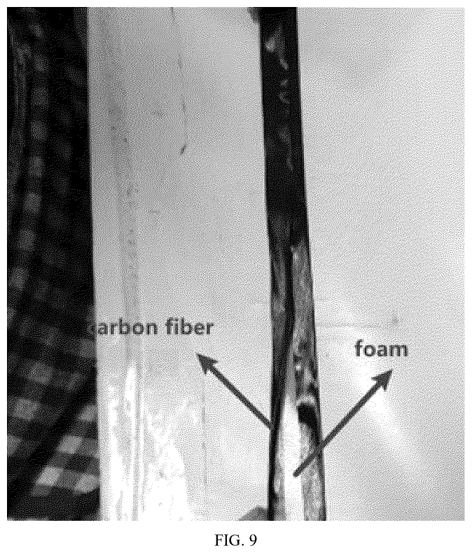

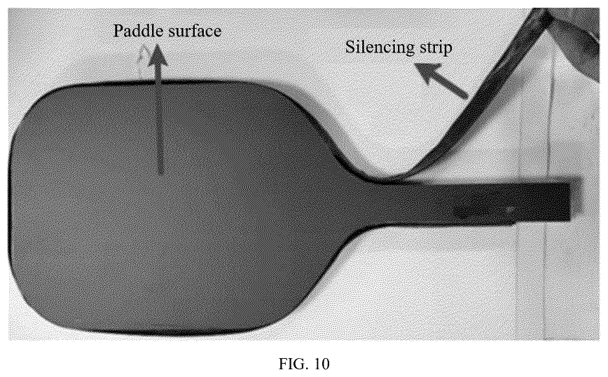

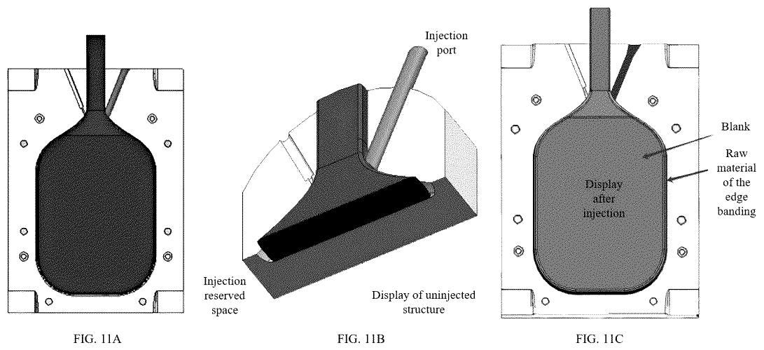

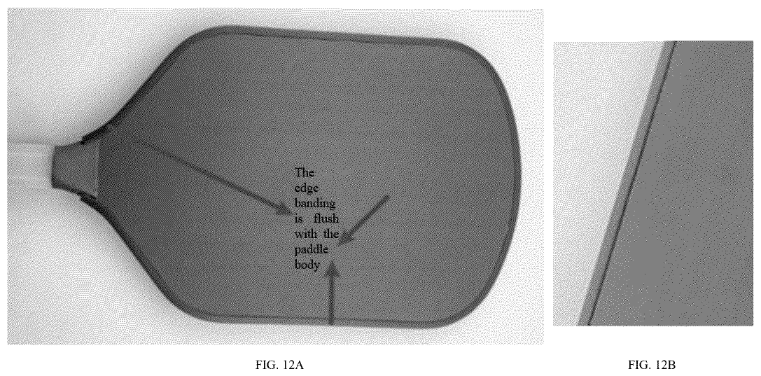

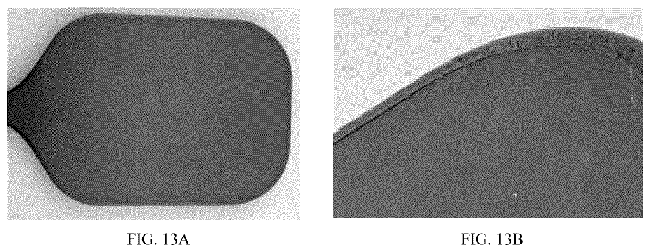

### DETAILED DESCRIPTION OF THE EMBODIMENTS

The technical scheme in the embodiment of the present invention will be described clearly and completely below. Obviously, the described embodiment is only a part of the embodiment of the present invention, not all of the embodiments. Based on the embodiment of the present invention, all other embodiments obtained by ordinary technicians in this field without creative work belong to the scope of protection of the present invention.

The raw materials used in the embodiments of the present invention were purchased from the following manufacturers.

Polyvinyl fluoride, purchased from DuPont, USA, model ETFE 230.

Epoxy resin, purchased from Merck, model 31185.

ABS resin was purchased from Lotte Chemical ABS resin, model SD-0150/BK.

Silicone oil, purchased from Merck, model 317667.

Organic bismuth catalyst, purchased from Shanghai Deyin Chemical Co., Ltd., model organic bismuth catalyst DY-20.

### Example 1

This example provides an integrated structure pickleball paddle, the pickleball paddle includes a paddle body, an edge banding, and a handle, the edge banding and the paddle body are fused into an integrated structure by hot pressing, the material of the edge banding is a modified TPU composite material, and the modified TPU composite material includes the following raw materials in parts by mass: 95 parts of modified TPU, 12 parts of polyvinyl fluoride, 24 parts of epoxy resin, 16 parts of ABS resin, 7 parts of modified nano-silicon dioxide, 0.5 parts of antioxidant, 0.3 parts of fluidity aid, 6 parts of 4,4′-methylene-bis(2-chloroaniline), and 5 parts of silicone oil.

The preparation method of the modified TPU is as follows:
Mixing polyether diol, silicone prepolymer, diphenylmethane diisocyanate, and organic bismuth catalyst in a mass ratio of 27:26:20:0.04, heating to 83° C., and maintaining the temperature and reacting for 4.6 h to obtain polyurethane prepolymer;
Mixing propylene glycol, trimethylolpropane, and polyurethane prepolymer in a mass ratio of 1:0.6:96, continuing to react at 83° C. for 3.5 h, capping and cooling to obtain modified TPU.

The weight average molecular weight of the polyether diol is 1000-3000.

The silicone prepolymer is a compound of model Silok®8832F4 silicone prepolymer (Guangzhou Silok), model ChangFu®SP-DN46 silicone prepolymer (Hubei Changfu Chemical Co., Ltd.), and model Silmer NH Di-50 (Stai Chemical) silicone prepolymer with a mass ratio of 1:0.3:0.6.

The fluidity aid is BASF ADP-1200.

The antioxidant is antioxidant-264.

The preparation method of the modified nano-silicon dioxide is: mixing nano-silicon dioxide, solvent, and silicone resin in a mass ratio of 1:11:0.06 evenly, stirring at 32° C. for 3.6 h, and removing the solvent and drying to obtain modified nano-silicon dioxide.

The solvent is a compound of acetone and ethanol with a mass ratio of 1:1.

The model of the silicone resin is Merck, SYLGARD® 184.

The preparation method of the composite material is: mixing modified polyurethane, polyvinyl fluoride, epoxy resin, ABS resin, and 4,4′-methylene-bis(2-chloroaniline) evenly, stirring at a temperature of 230° C. for 5 h, cooling to 135° C., adding the remaining raw materials, and maintaining the temperature and stirring for 3.5 h to obtain a modified TPU composite material.

The preparation process of the integrated structure pickleball paddle includes the following steps:
Step 1: Cut the paddle core and the paddle surface into a paddle shape.

The paddle core material is polypropylene honeycomb (PP core). The paddle surface is carbon fiber. To make a paddle, the raw materials need to be cut into a specific paddle shape.
Step 2: Make a silencing foam strip.

Use strip-shaped carbon fiber cloth to wrap the foam material to form a silencing strip.
Step 3: Assemble the paddle core, surface, and foam strip into a paddle body.

Put the cut surface on the paddle core, and wrap the silencing strip around the paddle core to form a blank, that is, the paddle body. The blank in this process is not integrated, that is, the paddle core, surface, and silencing strip are not fused into one.
Step 4: Hot pressing.

The mold used in the paddle production process is a customized mold. There is a space between the blank and the mold for injecting the raw material of the edge banding. The mold has an injection port for injecting the raw material of the edge banding. After high-temperature hot pressing, the edge banding and the paddle body are fused together to form a super-integrated paddle.
Step 5: Print the pattern on the surface of the paddle body.
Step 6: Install the handle.

### Example 2

The difference between this example and Example 1 is: an integrated structure pickleball paddle, the pickleball paddle includes a paddle body, an edge banding, and a handle, the edge banding and the paddle body are fused into an integrated structure by hot pressing, the material of the edge banding is a modified TPU composite material, and the modified TPU composite material includes the following raw materials in parts by mass: 90 parts of modified TPU, 9 parts of polyvinyl fluoride, 20 parts of epoxy resin, 20 parts ofABS resin, 5 parts of modified nano-silicon dioxide, 0.3 parts of antioxidant, 0.5 parts of fluidity aid, 4 parts of 4,4′-methylene-bis(2-chloroaniline), and 7 parts of silicone oil.

The preparation method of the modified TPU is as follows:
(1) Mixing polyether diol, silicone prepolymer, diphenylmethane diisocyanate, and organic bismuth catalyst in a mass ratio of 25:30:18:0.05, heating to 84° C., and maintaining the temperature and reacting for 4 h to obtain polyurethane prepolymer;
(2) Mixing propylene glycol, trimethylolpropane, and polyurethane prepolymer in a mass ratio of 1:0.4:100, continuing to react at 82° C. for 4 h, capping, cooling to obtain modified TPU.

The weight average molecular weight of the polyether diol is 1000-3000.

The silicone prepolymer is a compound of model Silok® 8832F4 silicone prepolymer (Guangzhou Silok), model ChangFu® SP-DN46 silicone prepolymer (Hubei Changfu Chemical Co., Ltd.), and model Silmer NH Di-50 (Stai Chemical) silicone prepolymer with a mass ratio of 1:0.2:0.7.

The fluidity aid is BASF ADP-1200.

The antioxidant is antioxidant-1010.

The preparation method of the modified nano-silicon dioxide is: mixing nano-silicon dioxide, solvent, and silicone resin in a mass ratio of 1:12:0.08, stirring at 35° C. for 3 h, removing the solvent and drying to obtain modified nano-silicon dioxide.

The solvent is a compound of acetone and ethanol with a mass ratio of 1:1.

The model of the silicone resin is Merck, SYLGARD® 184.

The preparation method of the composite material is: mixing modified polyurethane, polyvinyl fluoride, epoxy resin, ABS resin, and 4,4′-methylene-bis(2-chloroaniline) evenly, stirring at a temperature of 240° C. for 4 h, cooling to 140° C., adding the remaining raw materials, and maintaining the temperature and stirring for 3 h to obtain a modified TPU composite material.

### Comparative Example 1

The difference between this comparative example and Example 1 is that the modified TPU composite material includes the following raw materials in parts by mass: 95 parts of TPU, 12 parts of polyvinyl fluoride, 24 parts of epoxy resin, 16 parts of ABS resin, 7 parts of modified nano-silicon dioxide, 0.5 parts of antioxidant, 0.3 parts of fluidity aid, 6 parts of 4,4′-methylene-bis(2-chloroaniline), and 5 parts of silicone oil.

The preparation method of the TPU is as follows:
Mixing polyether diol, diphenylmethane diisocyanate, and organic bismuth catalyst in a mass ratio of 27:20:0.04, heating to 83° C., and maintaining the temperature and reacting for 4.6 h to obtain polyurethane prepolymer;
Mixing propylene glycol, trimethylolpropane, and polyurethane prepolymer in a mass ratio of 1:0.6:96, continuing to react at 83° C. for 3.5 h, capping and cooling to obtain modified TPU.

The weight average molecular weight of the polyether diol is 1000-3000.

### Comparative Example 2

The difference between this comparative example and Example 1 is that the silicone prepolymer is model Silok®8832F4 silicone prepolymer (Guangzhou Silok).

### Comparative Example 3

The difference between this comparative example and Example 1 is that the silicone prepolymer is a compound of model Silok®8832F4 silicone prepolymer (Guangzhou Silok), model ChangFu® SP-DN46 silicone prepolymer (Hubei Changfu Chemical Co., Ltd.), and model Silmer NH Di-50 silicone prepolymer (Stai Chemical) with a mass ratio of 1:1:1.

### Comparative Example 4

The difference between this comparative example and Example 1 is that the preparation method of the modified nano-silicon dioxide is: mixing nano-silicon dioxide, water, ethanol, and silane coupling agent kh550 in a mass ratio of 1:5:5:0.06, stirring at 45° C. for 4 h, removing the ethanol and water and drying to obtain modified nano-silicon dioxide.

### Comparative Example 5

The difference between this comparative example and Example 1 is that the modified TPU composite material includes the following raw materials in parts by mass: 95 parts of modified TPU, 16 parts of polyvinyl fluoride, 12 parts of epoxy resin, 24 parts of ABS resin, 7 parts of modified nano-silicon dioxide, 0.5 parts of antioxidant, 0.3 parts of fluidity aid, 6 parts of 4,4′-methylene-bis(2-chloroaniline), and 5 parts of silicone oil.

### Comparative Example 6

The difference between this comparative example and Example 1 is that the modified TPU composite material includes the following raw materials in parts by mass: 120 parts of modified TPU, 20 parts of polyvinyl fluoride, 10 parts of epoxy resin, 5 parts of ABS resin, 13 parts of modified nano-silicon dioxide, 0.2 parts of antioxidant, 0.1 parts of fluidity aid, 3 parts of 4,4′-methylene-bis(2-chloroaniline), and 9 parts of silicone oil.

### Performance Test

The wear resistance test was carried out according to GB/T9867-2008 “Rubber, vulcanized or thermoplastic—Determination of abrasion resistance using a rotating cylindrical drum device”;

The tensile strength of TPU material was tested according to GB/T528-2009 “Rubber, vulcanized or thermoplastic—Determination of tensile stress-strain properties”.

The glass transition temperature was tested by the differential scanning calorimetry (DSC) analyzer of PE Company.

The specific performance test results can be found in Table 1.

TABLE 1
Performance test results

| | | | Glass | 5% |
|---|---|---|---|---|
| | Volume | Tensile | transition | Thermogravimetric |
| | wear | strength | temperature | temperature |
| | mm³ | MPa | Tg, ° C. | ° C. |
| Example 1 | 41 | 51.5 | −72 | 349 |
| Example 2 | 43 | 50.2 | −70 | 347 |
| Comparative | 51 | 43.1 | −60 | 326 |
| Example 1 | | | | |
| Comparative | 46 | 46.6 | −65 | 335 |
| Example 2 | | | | |
| Comparative | 45 | 47.9 | −67 | 340 |
| Example 3 | | | | |
| Comparative | 48 | 46.0 | −70 | 345 |
| Example 4 | | | | |
| Comparative | 52 | 42.6 | −57 | 323 |
| Example 5 | | | | |
| Comparative | 53 | 40.9 | −55 | 321 |
| Example 6 | | | | |

The results show that the comprehensive performance of the edge bandings of Examples 1-2 is better. Comparative Examples 1-6 show that the comprehensive performance decreases to varying degrees when the raw materials of the edge bandings are changed.

The above is a preferred embodiment of the present invention. It should be pointed out that for ordinary technicians in this technical field, several improvements and modifications can be made without departing from the principles of the present invention, and these improvements and modifications should also be regarded as the scope of protection of the present invention.

What is claimed is:

1. A super-integrated structure pickleball paddle, wherein the super-integrated structure pickleball paddle comprises a paddle body, an edge banding, and a handle, the edge banding and the paddle body are fused into an integrated structure by hot pressing, a material of the edge banding is a modified thermoplastic polyurethane (TPU) composite material, and the modified TPU composite material comprises the following raw materials in parts by mass: 90-100 parts of a modified TPU, 9-14 parts of polyvinyl fluoride, 20-30 parts of an epoxy resin, 10-20 parts of an acrylonitrile-butadiene-styrene (ABS) resin, 5-10 parts of a modified nano-silicon dioxide, 0.3-0.6 parts of an antioxidant, 0.2-0.5 parts of a fluidity aid, 4-9 parts of 4,4′-methylene-bis(2-chloroaniline), and 3-7 parts of silicone oil;
wherein a preparation method of the modified TPU is as follows:
(1) mixing polyether diol, a silicone prepolymer, diphenylmethane diisocyanate, and an organic bismuth catalyst in a mass ratio of (25-30):(25-30):(18-22):(0.03-0.05), heating to a temperature of 82-84° C., and maintaining the temperature of 82-84° C. and reacting for 4-5 h to obtain a polyurethane prepolymer; and
(2) mixing propylene glycol, trimethylolpropane, and the polyurethane prepolymer in a mass ratio of 1:(0.4-0.7):(90-100), continuing to react at 82-84° C. for 3-4 h, capping and cooling to obtain the modified TPU;
wherein the silicone prepolymer is at least one of: a compound of a model Silok®8832F4 silicone prepolymer, a model ChangFu®SP-DN46 silicone prepolymer, and a model Silmer NH Di-50 silicone prepolymer with a mass ratio of 1:(0.2-0.4):(0.5-0.7); and
a preparation method of the modified nano-silicon dioxide comprises: mixing nano-silicon dioxide, a solvent, and a silicone resin in a mass ratio of 1:(10-12):(0.04-0.08), stirring at 30-35° C. for 3-4 h, removing the solvent and drying to obtain the modified nano-silicon dioxide.

2. The super-integrated structure pickleball paddle according to claim 1, wherein a weight average molecular weight of the polyether diol is 1000-3000.

3. The super-integrated structure pickleball paddle according to claim 1, wherein the fluidity aid is BASF ADP-1200; and the antioxidant is selected from one or more of antioxidant-264, antioxidant-1010, and antioxidant-1076.

4. The super-integrated structure pickleball paddle according to claim 1, wherein the solvent is a compound of acetone and ethanol with a mass ratio of 1:1.

5. The super-integrated structure pickleball paddle according to claim 1, wherein a model of the silicone resin is Merck or SYLGARD® 184.

6. The super-integrated structure pickleball paddle according to claim 1, wherein a preparation method of the modified TPU composite material comprises: mixing the modified TPU, the polyvinyl fluoride, the epoxy resin, the ABS resin, and the 4,4′-methylene-bis(2-chloroaniline) evenly, stirring at a temperature of 220-240° C. for 4-6 h, cooling to a temperature of 130-140° C., adding remaining raw materials, and maintaining the temperature of 130-140° C. and stirring for 3-4 h to obtain the modified TPU composite material.

7. A preparation process of the super-integrated structure pickleball paddle according to claim 1, comprising the following steps:
step 1: cutting a paddle core and a paddle surface into a paddle shape;
step 2: making a silencing foam strip;
step 3: assembling the paddle core, the paddle surface, and the silencing foam strip into the paddle body;
step 4: hot pressing, heating to make the modified TPU composite material into a viscous flow state, leaving a space between the paddle body and a mold, wherein the mold has an injection port for injecting the modified TPU composite material in the viscous flow state, after high-temperature hot pressing, the edge banding and the paddle body are fused together;
step 5: printing a pattern on the paddle surface of the paddle body; and
step 6: installing the handle.

8. The preparation process according to claim 7, wherein a weight average molecular weight of the polyether diol used for preparing the modified TPU is 1000-3000.

9. The preparation process according to claim 7, wherein the fluidity aid of the modified TPU composite material is BASF ADP-1200; and the antioxidant of the modified TPU composite material is selected from one or more of antioxidant-264, antioxidant-1010, and antioxidant-1076.

10. The preparation process according to claim 7, wherein the solvent used for preparing the modified nano-silicon dioxide is a compound of acetone and ethanol with a mass ratio of 1:1.

11. The preparation process according to claim 7, wherein a model of the silicone resin used for preparing the modified nano-silicon dioxide is Merck or SYLGARD® 184.

12. The preparation process according to claim 7, wherein in the super-integrated structure pickleball paddle, a preparation method of the modified TPU composite material comprises: mixing the modified TPU, the polyvinyl fluoride, the epoxy resin, the ABS resin, and the 4,4′-methylene-bis(2-chloroaniline) evenly, stirring at a temperature of 220-240° C. for 4-6 h, cooling to a temperature of 130-140° C., adding remaining raw materials, and maintaining the temperature of 130-140° C. and stirring for 3-4 h to obtain the modified TPU composite material.
